(19) United States
(12) Patent Application Publication
(10) Pub. No.: US 2017/0300950 A1
(43) Pub. Date: Oct. 19, 2017

(54) Business Promotion System and Method

(71) Applicant: Oodles Corporation, San Ramon, CA (US)

(72) Inventors: Asheesh Barman, San Ramon, CA (US); Todd Myers, Sammamish, WA (US); Sajal Sahay, Pleasanton, CA (US); Julian Cohen, Chicago, IL (US)

(73) Assignee: Oodles Corporation

(21) Appl. No.: 15/487,536

(22) Filed: Apr. 14, 2017

Related U.S. Application Data
(60) Provisional application No. 62/324,445, filed on Apr. 19, 2016.

(51) Int. Cl. G06Q 30/02; G06Q 50/00

(52) U.S. Cl. CPC G06Q 30/0214; G06Q 50/01

(57) ABSTRACT

A business promotion system and method which encourages customers to visit a business together to redeem a promotion. The business promotion system and method generally includes a system and method which encourages users to share first-tier promotions with a minimum number of recipient users via a plurality of user devices to unlock a virtual badge and a second-tier promotion. Badged users who have earned a virtual badge may visit the business individually to redeem the second-tier promotion or may unlock a third-tier promotion by visiting the business with other badged users displaying a virtual badge on their badged user devices. In such a manner, customers may be encouraged not only to share promotions with other potential customers, but also to visit the business as a group to receive greater discounts and/or other incentives.

### CROSS REFERENCE TO RELATED APPLICATIONS

I hereby claim benefit under Title 35, United States Code, Section 119(e) of U.S. provisional patent application Ser. No. 62/324,445 filed Apr. 19, 2016. The 62/324,445 application is currently pending. The 62/324,445 application is hereby incorporated by reference into this application.

### STATEMENT REGARDING FEDERALLY SPONSORED RESEARCH OR DEVELOPMENT

Not applicable to this application.

### BACKGROUND

### Field

Example embodiments in general relate to a business promotion system and method which encourages customers to visit a business together to redeem a promotion.

### Related Art

Any discussion of the related art throughout the specification should in no way be considered as an admission that such related art is widely known or forms part of common general knowledge in the field.

Even in the age of social media, businesses struggle to bring customers to their door. While social media has improved awareness of businesses and effectuated the sharing of deals, it has also encouraged online shopping and generally created a disconnect between consumers which often limits the social aspects of visiting businesses.

Existing business models generally utilize promotions which are sent out to consumers via a wide range of mediums such as the Internet, radio and television. Consumers are encouraged to redeem the promotions only be the deal of the promotion. There is no incentive for the consumer to share the promotion with others, such as friends or families, or to visit the business together with such friends or families.

### SUMMARY

An example embodiment is directed to a business promotion system and method. The business promotion system and method includes a system and method which encourages users to share first-tier promotions with a minimum number of recipient users via a plurality of user devices to unlock a virtual badge and a second-tier promotion. Badged users who have earned a virtual badge may visit the business individually to redeem the second-tier promotion or may unlock a third-tier promotion by visiting the business with other badged users displaying a virtual badge on their badged user devices. In such a manner, customers may be encouraged not only to share promotions with other potential customers, but also to visit the business as a group to receive greater discounts and/or other incentives.

There has thus been outlined, rather broadly, some of the embodiments of the business promotion system and method in order that the detailed description thereof may be better understood, and in order that the present contribution to the art may be better appreciated. There are additional embodiments of the business promotion system and method that will be described hereinafter and that will form the subject matter of the claims appended hereto. In this respect, before explaining at least one embodiment of the business promotion system and method in detail, it is to be understood that the business promotion system and method is not limited in its application to the details of construction or to the arrangements of the components set forth in the following description or illustrated in the drawings. The business promotion system and method is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a block diagram of a business promotion system and method in accordance with an example embodiment.

FIG. 2 is a block diagram illustrating a promotion sharing tree of a business promotion system and method in accordance with an example embodiment.

FIG. 3 is a block diagram illustrating a second promotion sharing tree of a business promotion system and method in accordance with an example embodiment.

FIG. 4a is a perspective view of a user viewing a first-tier promotion on a user device.

FIG. 4b is a perspective view of a plurality of badged users sharing a promotion with a plurality of recipient users to redeem a second-tier promotion of a business promotion system and method in accordance with an example embodiment.

FIG. 4c is a perspective view of a plurality of badged users visiting a business together to redeem a third-tier promotion.

FIG. 5 is a front view of a user device displaying first-tier promotions of a business promotion system and method in accordance with an example embodiment.

FIG. 6 is a front view of a user device being used to share first-tier promotions with recipient user devices of a business promotion system and method in accordance with an example embodiment.

FIG. 7 is a front view of a badged user device displaying a virtual badge of a business promotion system and method in accordance with an example embodiment.

FIG. 8 is a front view of a user device displaying a first-tier promotion of a business promotion system and method in accordance with an example embodiment.

FIG. 9 is a front view of a user device displaying a second-tier promotion of a business promotion system and method in accordance with an example embodiment.

FIG. 10 is a front view of a user device displaying a third-tier promotion of a business promotion system and method in accordance with an example embodiment.

FIG. 11 is a flowchart illustrating transmission of a first-tier promotion to a user device of a business promotion system and method in accordance with an example embodiment.

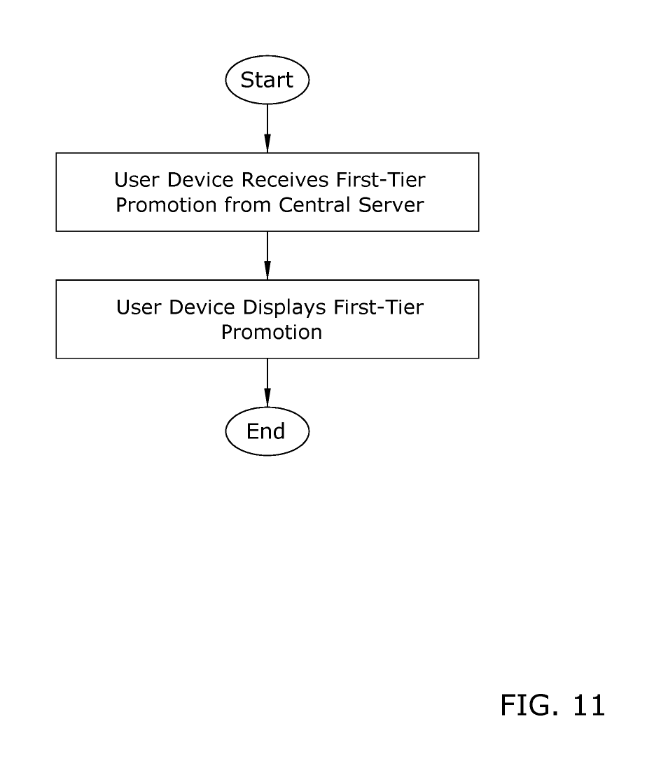

FIG. 12 is a flowchart illustrating sharing of a first-tier promotion by a user device with recipient users of a business promotion system and method in accordance with an example embodiment.

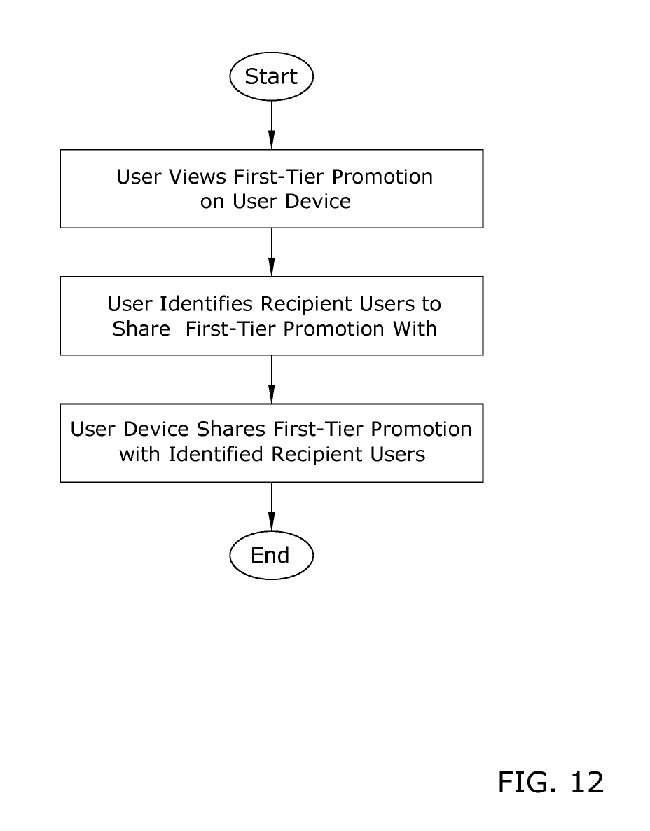

FIG. 13 is a flowchart illustrating an initial set-up by a business of a promotion of a business promotion system and method in accordance with an example embodiment.

FIG. 14 is a flowchart illustrating the earning of a virtual badge by reaching a minimum number of shares by a user device of a business promotion system and method in accordance with an example embodiment.

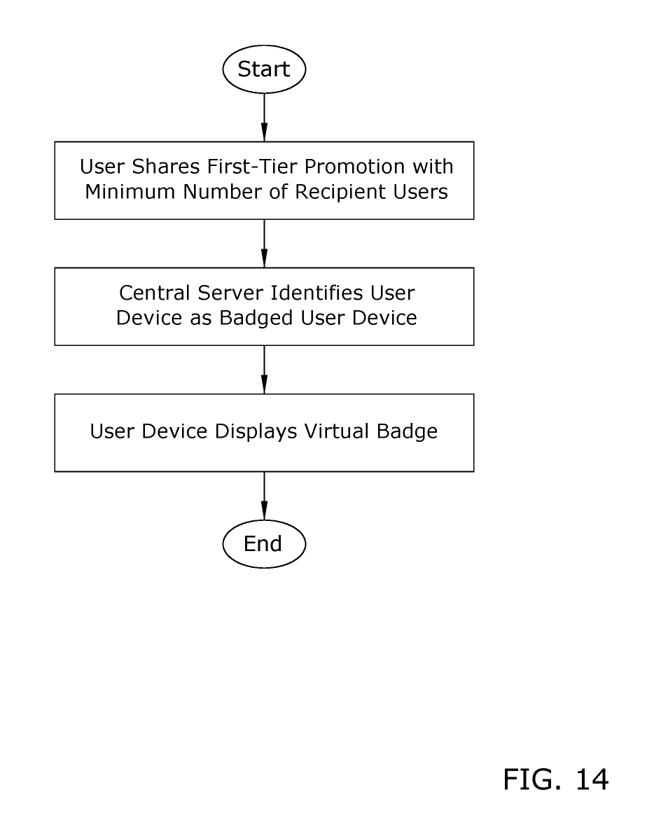

FIG. 15 is a flowchart illustrating the offering of a second-tier promotion upon earning a virtual badge of a business promotion system and method in accordance with an example embodiment.

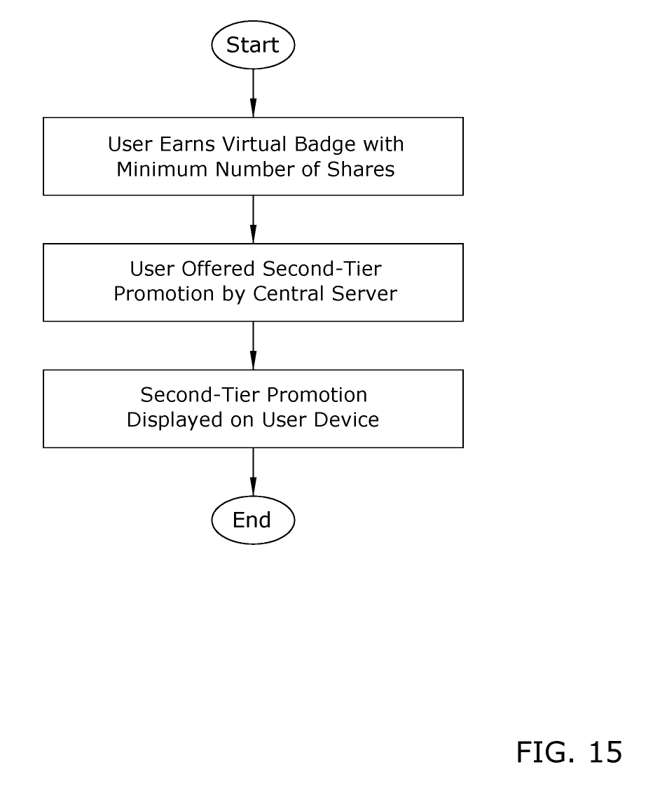

FIG. 16 is a flowchart illustrating visiting a business together by badged users to earn a third-tier promotion of a business promotion system and method in accordance with an example embodiment.

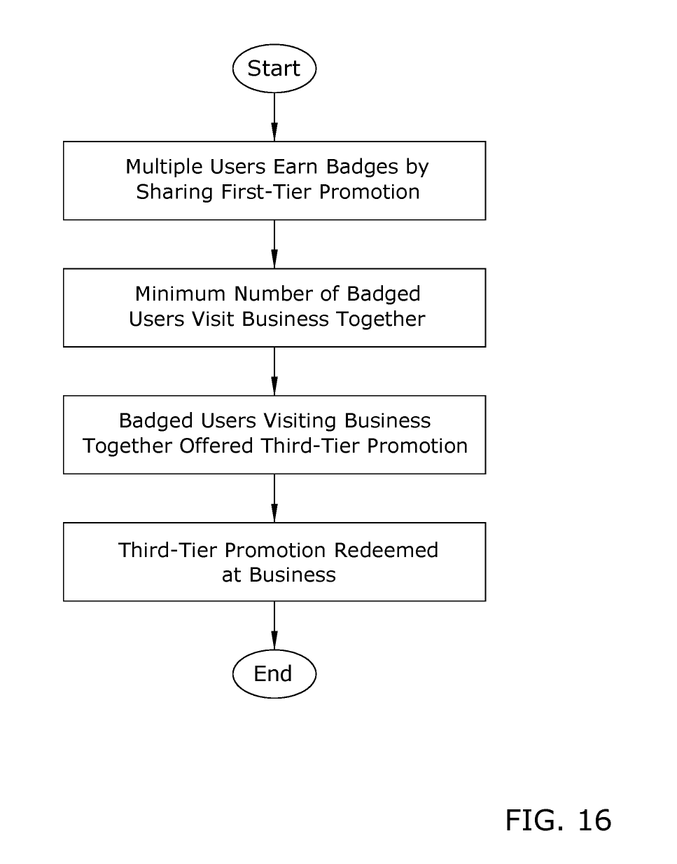

### DETAILED DESCRIPTION

### A. Overview.

An example business promotion system and method 10 generally includes a system and method which encourages users to share first-tier promotions with a minimum number of recipient users via a plurality of user devices 20 to unlock a virtual badge 44 and a second-tier promotion. Badged users who have earned a virtual badge 44 may visit the business individually to redeem the second-tier promotion or may unlock a third-tier promotion by visiting the business with other badged users displaying a virtual badge 44 on their badged user devices 22. In such a manner, customers may be encouraged not only to share promotions with other potential customers, but also to visit the business as a group to receive greater discounts and/or other incentives.

Broadly speaking, a method of promoting a business is disclosed which includes the steps of transmitting a first-tier promotion for a business from a central server 30 to a first user device 20, wherein the first-tier promotion comprises a base offer, then displaying the first-tier promotion for the business on the first user device 20. The first user device 20 then shares the promotion with a minimum number of recipient user devices 20 by communicating the promotion from the first user device 20 to the minimum number of recipient user devices 20. The first user device 20 may unlock a virtual badge 44 by reaching the minimum number of shares, with the central server 30 identifying the first user device 20 as a first badged device 22 the first-tier promotion has been shared with the minimum number of recipient user devices 20 by the first user device 20. The first badged device 22 may then display the virtual badge 44 to receive a second-tier promotion for the business from the central server 30, wherein the second-tier promotion comprises the base offer and a first discount and/or other incentive. The same steps may be performed with a second user device 20. If the first and second badged devices 20 visit the business together, they may be offered a third-tier promotion comprising a base offer and a second discount and/or other incentive.

Put differently, a method of promoting a business is disclosed which includes the steps of offering a first-tier promotion for a business to a plurality of users via a plurality of user devices 20 by a central server 30, wherein the first-tier promotion comprises a base offer; sharing the first-tier promotion by the plurality of users; identifying any of the plurality of users who share the first-tier promotion a minimum number of shares as a plurality of badged users; and offering a second-tier promotion to the plurality of badged users via the plurality of user devices by the central server, wherein the second-tier promotion comprises the base offer and a first discount and/or other incentive. If a minimum number of badged users visit the business together, they will be offered a third-tier promotion which comprises the base offer and a second discount and/or other incentive, with the second discount and/or other incentive being greater than the first discount and/or other incentive.

### B. Exemplary Telecommunications Networks.

The business promotion system and method 10 may be utilized upon any communications network 12 capable of transmitting data including voice data and other types of electronic data. Examples of suitable communications networks 12 for the business promotion system and method 10 include but are not limited to global computer networks (e.g. Internet), wireless networks, cellular networks, satellite communications networks, cable communication networks (via a cable modem), microwave communications network, local area networks (LAN), wide area networks (WAN), campus area networks (CAN), metropolitan-area networks (MAN), and home area networks (HAN).

The business promotion system and method 10 may communicate via a single communications network 12 or multiple communications networks 12 concurrently. Various protocols may be utilized by the user devices 20 for communications such as but not limited to HTTP, SMTP, FTP and WAP (wireless Application Protocol). The business promotion system and method 10 may be implemented upon various wireless networks such as but not limited to 3G, 4G, LTE, CDPD, CDMA, GSM, PDC, PHS, TDMA, FLEX, REFLEX, IDEN, TETRA, DECT, DATATAC, and MOBITEX. The business promotion system and method 10 may also be utilized with online services and internet service providers.

The Internet is an exemplary communications network 12 for the business promotion system and method 10. The Internet is comprised of a global computer network having a plurality of computer systems such as user devices 20 and/or a central server 30 around the world that are in communication with one another. Via the Internet, the computer systems are able to transmit various types of data between one another. The communications between the computer systems may be accomplished via various methods such as but not limited to wireless, Ethernet, cable, direct connection, telephone lines, and satellite.

### C. Central Server.

The systems and methods described herein may rely upon a central server 30 which acts as a central relay point for communicating promotions to user devices 20, effectuating the sharing of promotions among user devices 20, and identification of certain user devices 20 as badged user devices 22 upon reaching a set minimum number of shares by any of the user devices 20.

The central server 30 may comprise a single computer system or multiple computer systems. The central server 30 may be located at a central location or distributed across different locations; with communications established via the communications network 12. The central server 30 may be located at the business itself, or may be at a third-party location and communicate with various businesses via the communications network 12.

The central server 30 may be comprised of any central communication site where communications are preferably established with. The central server 30 may be comprised of a server computer, cloud based computer, virtual computer, home computer or other computer system capable of receiving and transmitting data via IP networks and the telecommunication networks. As can be appreciated, a modem or other communication device may be required between each of the computer systems of the central server 30 and the corresponding communications networks 12. The central server 30 may be comprised of any electronic system capable of receiving and transmitting information (e.g. voice data, computer data, etc.).

### D. User Devices.

User devices 20 are utilized for performing various functionality of the business promotion system and method 10, such as but not limited to receiving promotions from the central server 30, displaying promotions, identifying other user devices 20 to share the promotions with, and/or communicating the promotions with the other user devices 20. Generally, each of the user devices 20 will be communicatively interconnected to the communications network 12 so that the user devices 20 may communicate with each other as well as with the central server 30.

It should be appreciated that various types of user devices 20 may be utilized with the business promotion system and method 10. Further, there is no requirement of uniformity among user devices 20 used within the business promotion system and method 10 described herein. More specifically, a first user device 20a may be comprised of a smart phone while a second user device 20b may be comprised of a laptop computer. Although it is preferred that the user device 20 comprises a mobile electronic device, in some embodiments the user device 20 may not be mobile (such as a desktop computer).

The user device 20 may execute a software program to perform the various functions of the business promotion system and method 10. The user device 20 may utilize various operating systems, such as WINDOWS, IOS, or ANDROID. The software program may be installed to the user device 20 by the user, or may be native to the user device 20 (such as by being incorporated into its operating system). The software program may also be executed through a web browser on the user device 20 in some embodiments.

The user device 20 may be comprised of any type of computer for practicing the various aspects of the business promotion system and method 10. For example, the user device 20 can be a personal computer (e.g. APPLE® based computer, an IBM based computer, or compatible thereof) or tablet computer (e.g. IPAD®).

The user device 20 may also be comprised of various other electronic devices capable of sending and receiving electronic data including but not limited to smartphones, mobile phones, telephones, personal digital assistants (PDAs), mobile electronic devices, handheld wireless devices, two-way radios, smart phones, communicators, video viewing units, television units, television receivers, cable television receivers, pagers, communication devices, and digital satellite receiver units.

The user device 20 may comprised of any conventional computer. A conventional computer preferably includes a display screen (or monitor), a printer, a hard disk drive, a network interface, and a keyboard. A conventional computer also includes a microprocessor, a memory bus, random access memory (RAM), read only memory (ROM), a peripheral bus, and a keyboard controller. The microprocessor is a general-purpose digital processor that controls the operation of the computer. The microprocessor can be a single-chip processor or implemented with multiple components. Using instructions retrieved from memory, the microprocessor controls the reception and manipulations of input data and the output and display of data on output devices. The memory bus is utilized by the microprocessor to access the RAM and the ROM. RAM is used by microprocessor as a general storage area and as scratch-pad memory, and can also be used to store input data and processed data. ROM can be used to store instructions or program code followed by microprocessor as well as other data. A peripheral bus is used to access the input, output and storage devices used by the computer. In the described embodiments, these devices include a display screen, a printer device, a hard disk drive, and a network interface. A keyboard controller is used to receive input from the keyboard and send decoded symbols for each pressed key to microprocessor over bus. The keyboard is used by a user to input commands and other instructions to the computer system. Other types of user input devices can also be used in conjunction with the business promotion system and method. For example, pointing devices such as a computer mouse, a track ball, a stylus, or a tablet to manipulate a pointer on a screen of the computer system. The display screen is an output device that displays images of data provided by the microprocessor via the peripheral bus or provided by other components in the computer. The printer device when operating as a printer provides an image on a sheet of paper or a similar surface. The hard disk drive can be utilized to store various types of data. The microprocessor together with an operating system operate to execute computer code and produce and use data. The computer code and data may reside on RAM, ROM, or hard disk drive. The computer code and data can also reside on a removable program medium and loaded or installed onto computer system when needed. Removable program mediums include, for example, CD-ROM, PC-CARD, USB drives, floppy disk and magnetic tape. The network interface circuit is utilized to send and receive data over a network connected to other computer systems. An interface card or similar device and appropriate software implemented by microprocessor can be utilized to connect the computer system to an existing network and transfer data according to standard protocols.

### E. Method of Promoting a Business.

The business promotion system and method 10 is utilized to encourage users to share a promotion for a business with other users to earn a discount and/or other incentive on goods/services. The business promotion system and method 10 further encourages user who have shared the promotion to visit the business together as a group to earn even further discounts and/or other incentives on goods/services.

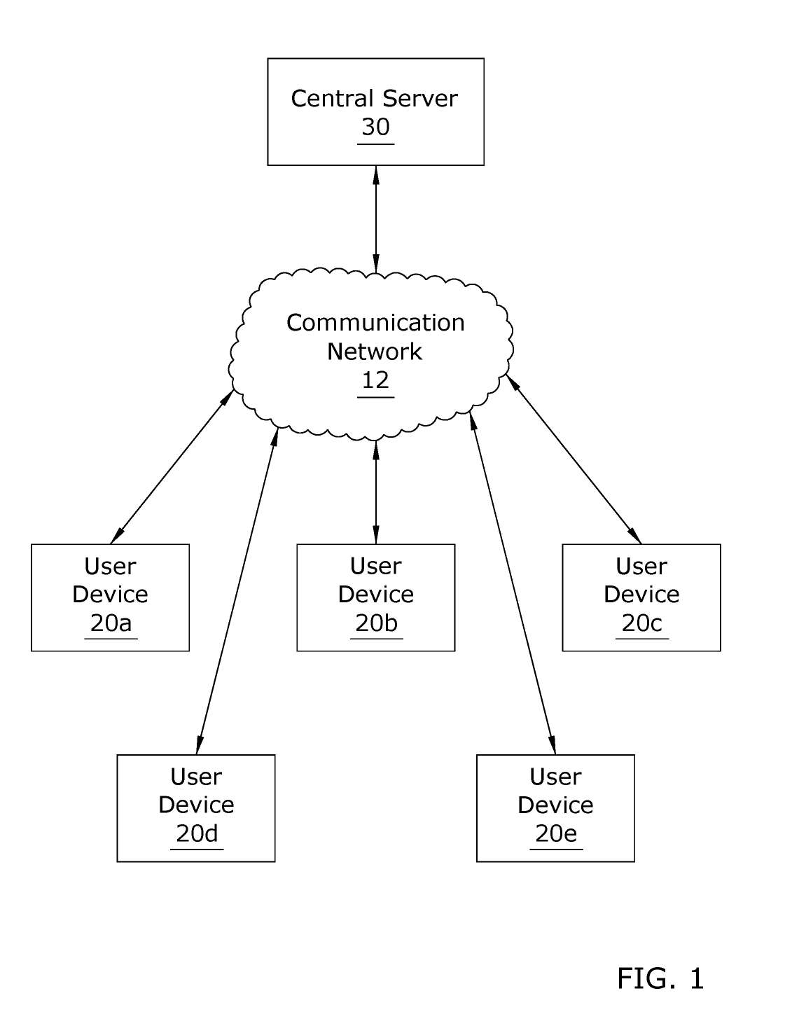

FIG. 1 is a block diagram of an exemplary business promotion system 10 which illustrates one embodiment of the interconnection of the various components of the business promotion system 10. As shown in FIG. 1, a plurality of user devices 20 are communicatively interconnected with a central server 30 via a communications network 12.

FIG. 1 illustrates a first user device 20a, a second user device 20b, a third user device 20c, a fourth user device 20d, and a fifth user device 20e. It should appreciated that the illustration of five user devices 20 is merely for exemplary purposes. It is expected that the central server 12 may transmit promotions to a large number of user devices 20. It should not be construed in any manner that the business promotion system 10 is limited in any way by the number of user devices 20. More or less user devices 20 may be communicatively interconnected with the central server 30 in different embodiments or at different times of operation of the business promotion system 10.

What follows is a general description of one embodiment of the business promotion system and method 10. A multi-tier promotion approach is utilized to encourage users to not just redeem the promotion, but also to encourage others to redeem the promotion together at the business.

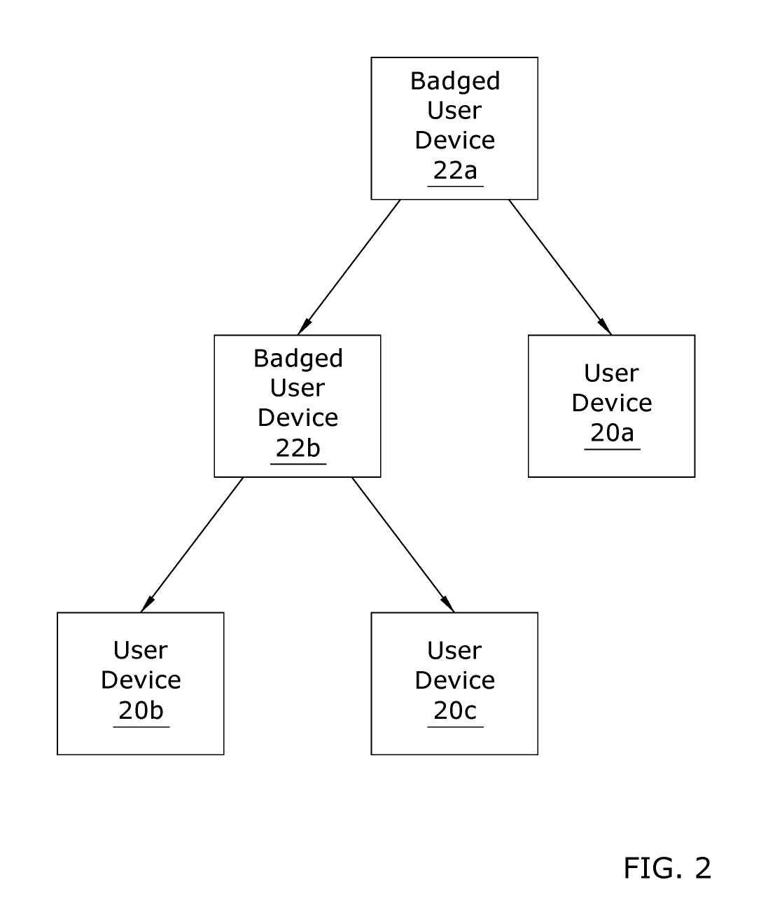

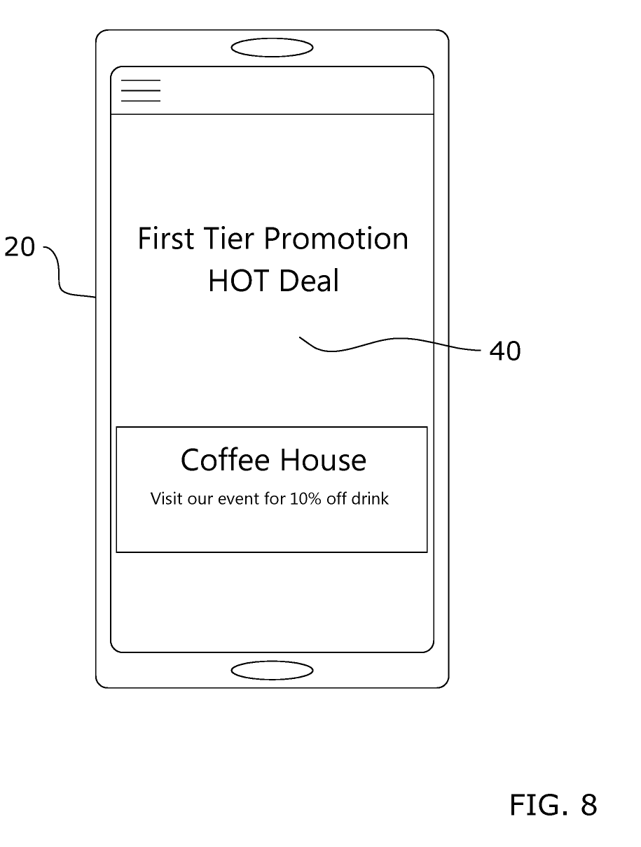

FIGS. 2, 3, 8-10 illustrate the three tiers of the promotion. A first-tier promotion is offered to any user via their user device 20. The user is informed via the user device 20 that, if the first-tier promotion is shared with a minimum number of recipient user devices 20, the user will earn a virtual badge 44 that may be used to redeem the second- and/or third-tier promotions.

Upon earning the virtual badge 44 by sharing the first-tier promotion with the minimum number of recipient user devices 20, the central server 30 will identify that particular user device 20 as a badged user device 22. The badged user device 22 is then offered the second-tier promotion which will generally be a better deal (such as a greater discount and/or other incentive or additional free goods/services) than the base offer of the first-tier promotion.

Badged users are offered a third-tier promotion via their badged user devices 22 that is generally a better deal or with more incentive than both the first-tier promotion and the second-tier promotion. The third-tier promotion may be redeemed by visiting the business together with a minimum number of other badged users; each bringing along their badged user devices 22 so that the virtual badges 44 may be shown to the business. By visiting the business together, the badged users may obtain the most desirable deals, which encourages customers to visit the business together.

Generally speaking, a first-tier promotion is communicated to a plurality of users via a plurality of user devices 20. The first-tier promotion may be “pushed” to the user via the user device 20, such as by inclusion in a banner advertisement on a webpage or by sending out emails, text messages (SMS), or the like to the user devices 20. Alternatively, the first-tier promotion may be “pulled” by the user via the user device 20, such as by downloading and executing a software program related to such first-tier promotions with the user device 20.

The first-tier promotion may comprise a base offer relating to a good or service offered by the business; or may relate to encouraging attendance at an event planned at the business. For example, if the business is a retailer of goods, the first-tier promotion may comprise a base offer of a discount and/or other incentive on the normal retail price of goods offered by the business. An example would be a business comprised of a sporting goods store which offers a base offer comprised of a discount and/or other incentive on a pair of ice skates being sold by the business.

If the business is a retailer of services, the first-tier promotion may comprise a base offer of a discount and/or other incentive on the normal price of services offered by the business. An example would be a business comprised of a tanning salon which offers a base offer comprised of a free period of time for tanning offered by the business.

In some circumstances, a business may be holding an event to which the business wants to attract customers. By way of example, a business may be holding a pizza party and offer a base offer comprising a free pizza for any users who attend the pizza party.

As an additional example, if the business is a restaurant, the first-tier promotion may comprise a base offer of a discount and/or other incentive on a certain food item offered by the restaurant, or a percentage discount and/or other incentive off a final bill. It should be appreciated that any number of deals, including free goods/services or discount and/or other incentiveed goods/services, may be offered as part of the first-tier promotion.

The first-tier promotion is communicated to the user devices 20 by the central server 30 either by “pushing” to the user devices 20 or being “pulled” by the user devices 20. The central server 30 may be located at the business or may be at a third-party location. In circumstances in which the central server 30 is not located at the business, a separate computer system may be utilized by the business to record the promotion with the central server 30. The central server 30 may then transmit the first-tier promotion to the user devices 20, or the user devices 20 may connect to the central server 30 via the communications network 12 and request promotions to view.

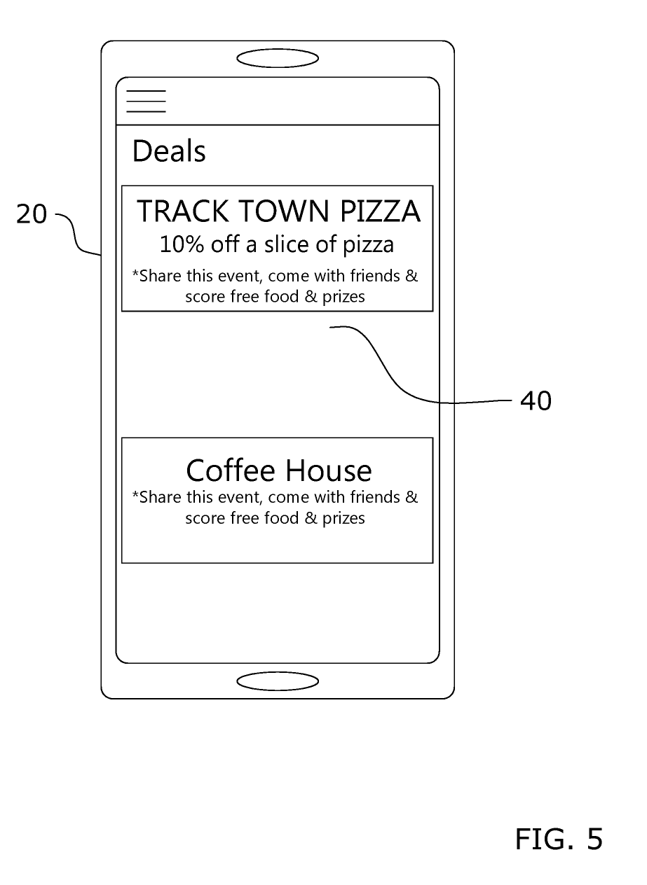

Users will generally be offered a range of first-tier promotions which are displayed on the user devices 20. FIG. 5 illustrates an exemplary interface 40 showing two first-tier promotions on a user device 20: a first-tier promotion offering a base deal on a slice of pizza and a first-tier promotion offering a base deal of free food and prizes for visiting an event.

These are merely exemplary illustrations and should not be construed as limiting on the scope of the present invention. The appearance of the interface 40 may vary widely in different embodiments; and the interface 40 has been simplified for purposes of the patent figures. In some embodiments, only a single first-tier promotion may be shown on the user device 20. In other embodiments, a listing of first-tier promotions may be shown on the user device 20 from which the user may select their desired first-tier promotion.

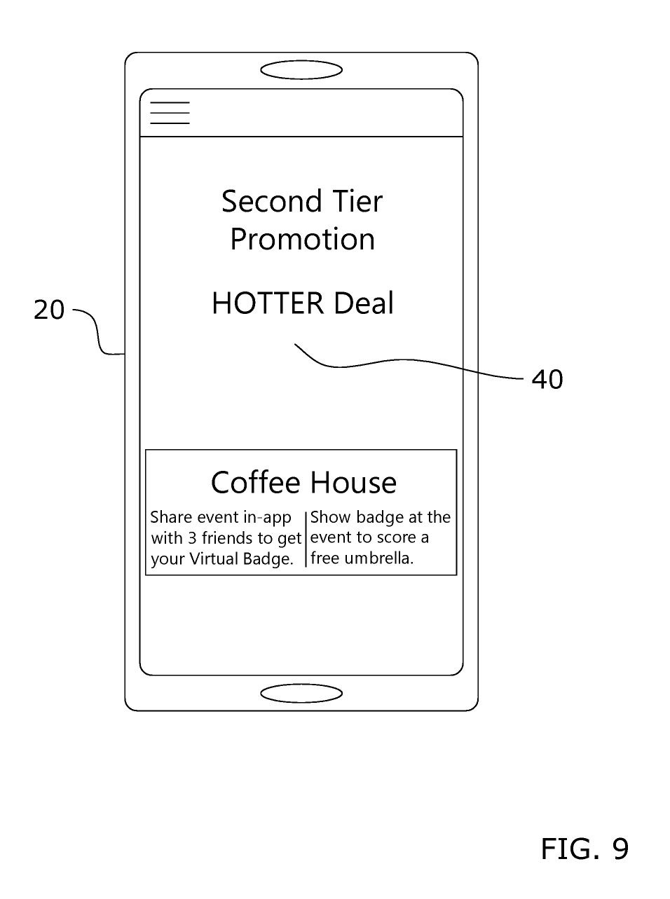

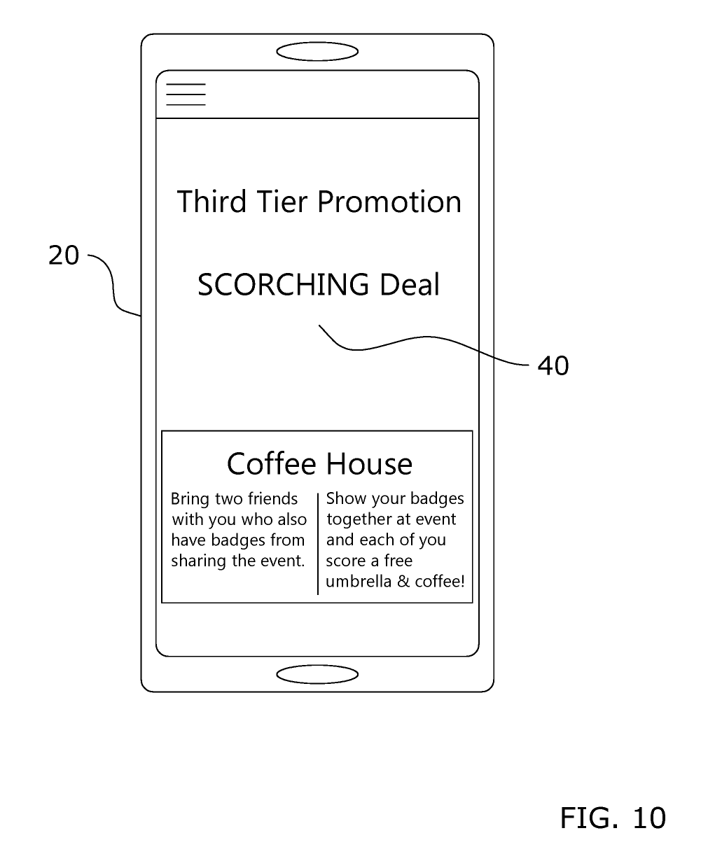

Upon selecting a first-tier promotion, a user may be informed of the second- and third-tier promotions to encourage the user to share the first-tier promotion and visit the business with others. FIGS. 9 and 10 illustrate exemplary interfaces 40 showing the second- and third-tier promotions to encourage a user to earn a virtual badge 44 and visit the business with other badged users. These figures are merely for exemplary purposes, as it should be appreciated that the user may be informed of the second- and third-tier promotions in a wide range of manners such as pop-ups or the like that are not shown in the exemplary figures.

The user will be encouraged to share the first-tier promotion with a minimum number of recipient users in order to earn a virtual badge 44 that unlocks a second-tier promotion and makes available a third-tier promotion. The minimum number of shares necessary to earn a virtual badge 44 may vary in different embodiments. In some embodiments, the minimum number of shares necessary to earn a virtual badge 44 may be set by the business.

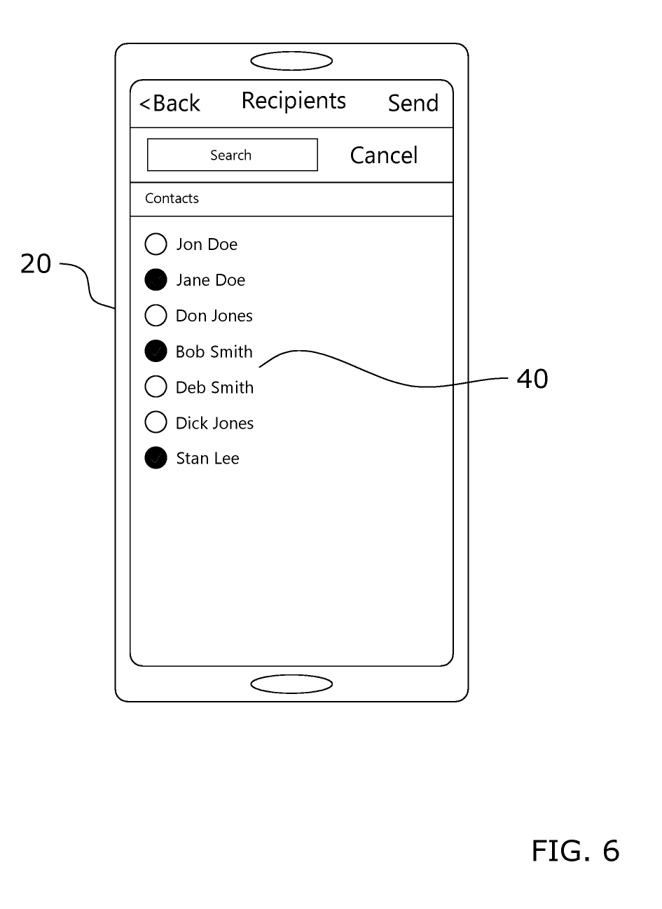

FIG. 6 illustrates an exemplary interface 40 through which the user may share the first-tier promotion with recipient user devices 20. The user may utilize the user device 20 to select from a list of recipient users to transmit the first-tier promotion to. This listing may include the contacts of the user or may contain a listing of individuals who the user does not know that is provided by the central server 20.

In either case, the user may select the recipient users with whom the first-tier promotion should be shared. The first-tier promotion will then be sent to those recipient users. The first-tier promotion may be shared in a number of manners, including but not limited to via email, via text message (SMS), via sending a link to a webpage, via other social media protocols or applications or via sending a link to download a software program to view the first-tier promotion. Additionally, the first-tier promotion may be shared by being communicated directly from the user device 20 (such as in the case of an SMS text message) or may be shared by communication from the central server 30 (such as in the case of the central server 30 sending an email to the recipient user).

After the minimum number of shares has been reached by the user with the user device 20, the user will earn a virtual badge 44. The virtual badge 44 is unique to the user and may be independently created in any of the tiers of promotion. The virtual badge 44 stays static once set-up by the business as described below and earned by the user. The virtual badge 44 unlocks the second-tier promotion and provides an opportunity to earn the third-tier promotion.

Upon reaching the minimum number of shares, the user device 20 will be issued a virtual badge 44 and identified as a badged user device 22 by the central server 30. The virtual badge 44 is generally issued by the central server 30 and displayed on the badged user device 22. In some embodiments, separate communication with the central server 30 may not be necessary for issuance and display of the virtual badge 44. In such cases, the user device 20 will internally issue the virtual badge 44 to be displayed.

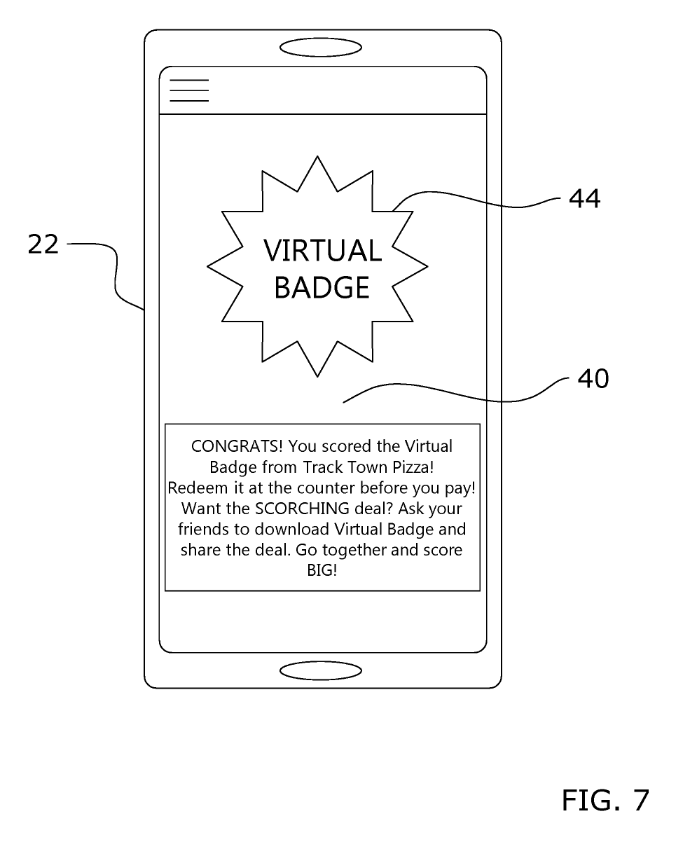

FIG. 7 illustrates an exemplary virtual badge 44 shown on an interface 40 of a badged user device 22. This virtual badge 44 is merely for exemplary illustrative purposes and should not be construed as limiting in any manner on the appearance of virtual badges 44 for use with the business promotion system 10. The virtual badge 44 will preferably be shown at the business to redeem the second-tier and/or third-tier promotions.

Upon earning a virtual badge 44, the user will be offered the second-tier promotion. The second-tier promotion generally comprises the base offer of the first-tier promotion in addition to a first discount and/or other incentive. For example, if the base offer is 10% off a coffee, the second-tier promotion may comprise the 10% base offer and a 5% first discount—resulting in a total of 15% off the coffee. In other embodiments, the first discount and/or other incentive could comprise a free item. For example, if the base offer is a free hat with any purchase, the second-tier promotion may comprise a set of free gloves in addition to the free hat.

To redeem the second-tier promotion, the user need only visit the business and show the virtual badge 44 on the badged user device 22. The business will then offer the user the second-tier promotion, which may be individually redeemed by any badged user device 22 at any time regardless of the presence of other badged users at that particular time.

If the badged user desires even more savings and/or incentives, the third-tier promotion may be unlocked by visiting the business with a minimum number of other badged users. The minimum number of badged users visiting a business together to unlock the third-tier promotion may be set by the business as discussed below.

Upon visiting the business together with other badged users, the group of badged users will display to the business their badged user devices 22 each displaying a unique virtual badge 44. The business will then offer the third-tier promotion to the group of badged users who visited the business together. This encourages groups of customers to visit a business together rather than individually.

The third-tier promotion generally comprises the base offer, first discount and/or other incentive, and a second discount and/or other incentive. For example, if the base offer is 10% off a coffee, and the first discount and/or other incentive is an additional 5% off the coffee, the second discount and/or other incentive could be yet another 5% off the coffee—resulting in the first-tier promotion being 10% off coffee, the second-tier promotion being 15% off coffee, and the third-tier promotion being 20% off coffee. With respect to the promotions relating to free items, the first-tier promotion may be a free hat, the second-tier promotion may be free gloves, and the third-tier promotion may be free boots.

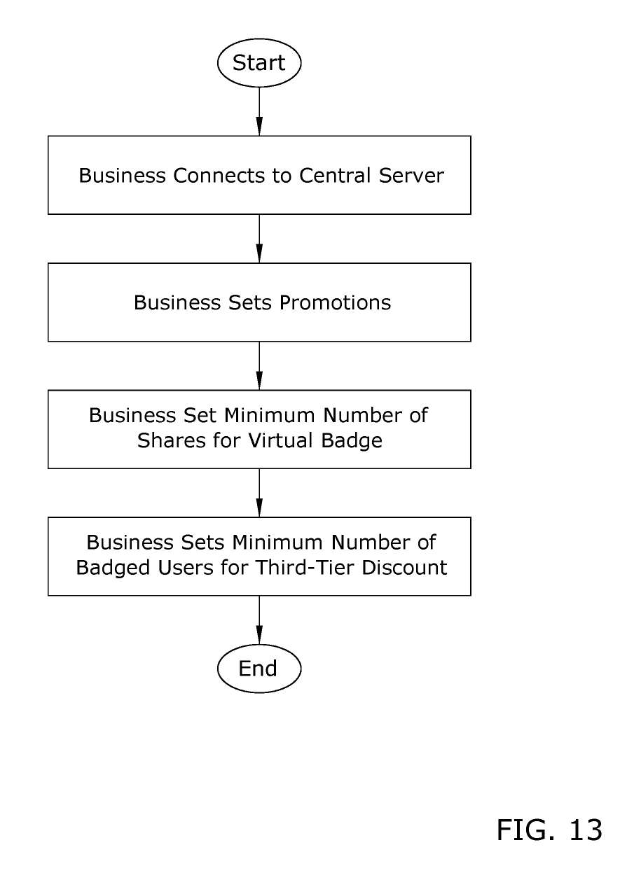

FIG. 13 is an exemplary flowchart illustrating an initial set-up method of a business offering promotions. The business promotion system 10 may allow the business owners to set up the promotions as well as the minimum number of shares and minimum number of badged users to unlock the second- and third-tiers of the promotions. In other embodiments, the central server 30 may set up the promotions and minimum number of shares/badged users without input from the business.

Continuing to reference FIG. 13, the business will first connect to the central server 30. The business will then define the promotion, including the details of the first-tier, second-tier, and third-tier of the promotion. Details provided may include the amount of any discounts and/or other incentives offered or any free items offered, as well as any other pertinent information related to the promotion being offered by the business.

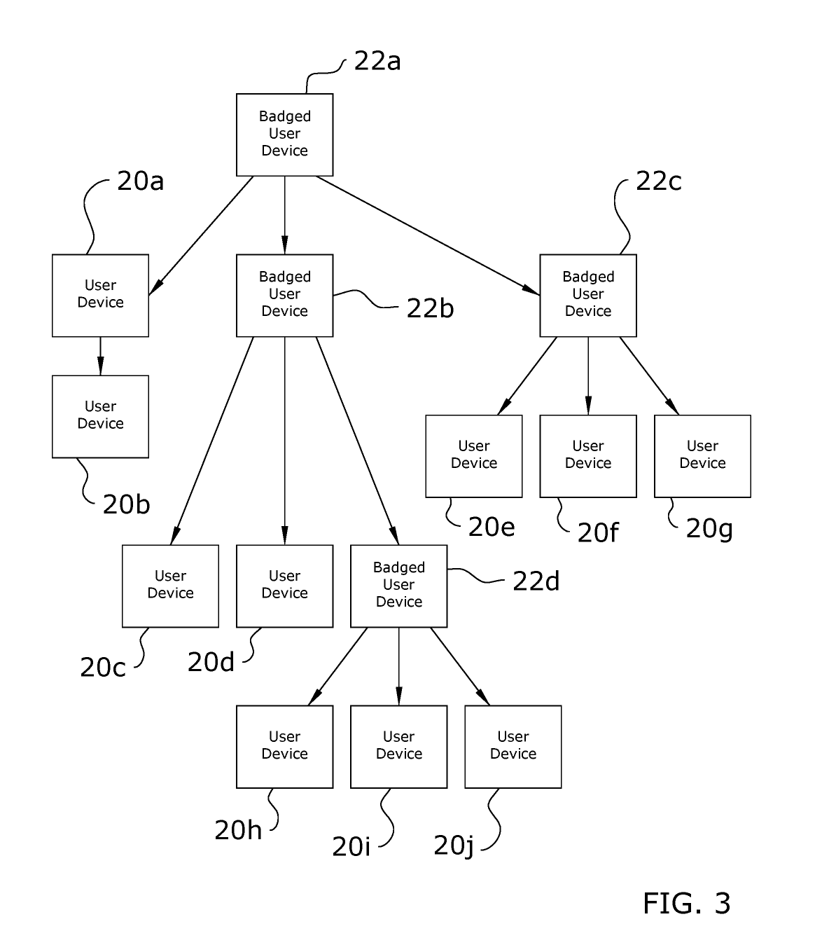

After setting up the promotion, including all three tiers of the base offer, first discount and/or other incentive, and second discount and/or other incentive, the business may set the minimum number of shares needed by a user device 20 before unlocking a virtual badge 44 to become a badged user device 22 and redeem the second-tier promotion. This number is entirely up to the business and may vary in different embodiments. FIG. 2 illustrates a promotion wherein a minimum number of two shares is necessary to unlock a virtual badge 44. FIG. 3 illustrates a promotion in which a minimum number of three shares is necessary to unlock a virtual badge 44.

After setting the minimum number of shares, the business may specify the minimum number of badged users who must visit the business together to unlock the third-tier promotion. This number may vary for businesses depending on their desired customer flow. During the course of a promotion, the business will also be free to adjust this number as needed based on feedback and experience as the promotion is being offered.

For example, if a business notices that badged users are struggling to group up into the minimum number of badged users, that minimum number may be lowered to encourage badged users to visit together. Alternatively, if a business notices that its third-tier promotion is being unlocked too often, the minimum number of badged users visiting together may be raised.

FIGS. 2 and 3 are different block diagrams illustrating two different “share trees” showing how a first-tier promotion is shared. In FIG. 2, the minimum number of shares necessary to unlock a virtual badge 44 is set at two shares. As can be seen, badged user device 22a has shared the first-tier promotion with badged user device 22b and user device 20a. User device 20a has not shared the first-tier promotion further and has not earned a virtual badge 44. Badged user device 22b has shared the first-tier promotion with user device 20b and user device 20c to unlock the virtual badge 44.

In the scenario of FIG. 2, badged user devices 22a, 22b are each offered the second-tier promotion and may individually visit the business to redeem the base offer and first discount and/or other incentive. User devices 20a, 20b, 20c have each received the first-tier promotion and may individually visit the business to redeem the base offer, but may not redeem the second-tier promotion with first discount and/or other incentive as they have not met the minimum number of shares. Badged user devices 22a, 22b may visit the business together to redeem the third-tier promotion comprising the base offer and second discount and/or other incentive; with the second discount and/or other incentive being greater than the first discount and/or other incentive.

FIG. 3 illustrates a “share tree” showing how a first-tier promotion is shared where the minimum number of shares necessary to unlock a virtual badge 44 is set at three shares. As can be seen, badged user device 22a has earned a virtual badge 44 by sharing the first-tier promotion with user device 20a, badged user device 22b, and badged user device 22c. User device 20a has shared the first-tier promotion with user device 20b. Badged user device 22b has earned a virtual badge 44 by sharing with user device 20c, user device 20d, and badged user device 22d. Badged user device 22c has earned a virtual badge 44 by sharing with user device 20e, user device 20f, and user device 20g. Badged user device 22d has earned a virtual badge 44 by sharing with user device 20h, user device 20i, and user device 20j.

Continuing to reference FIG. 3, badged user devices 22a, 22b, 22c, 22d have each unlocked the second-tier promotion which may be redeemed individually by any of the badged users by visiting the business with their badged user devices 22a, 22b, 22c, 22d and displaying their virtual badges 44. User devices 20a, 20b, 20c, 20d, 20e, 20f, 20g, 20h, 20i, 20j may redeem the first-tier promotions at the business but may not redeem the second-tier promotion as they have not reached the minimum number of shares to unlock a virtual badge 44. The badged user devices 22a, 22b, 22c, 22b may also go together to the business to unlock the third-tier promotion for an even greater discount and/or other incentive.

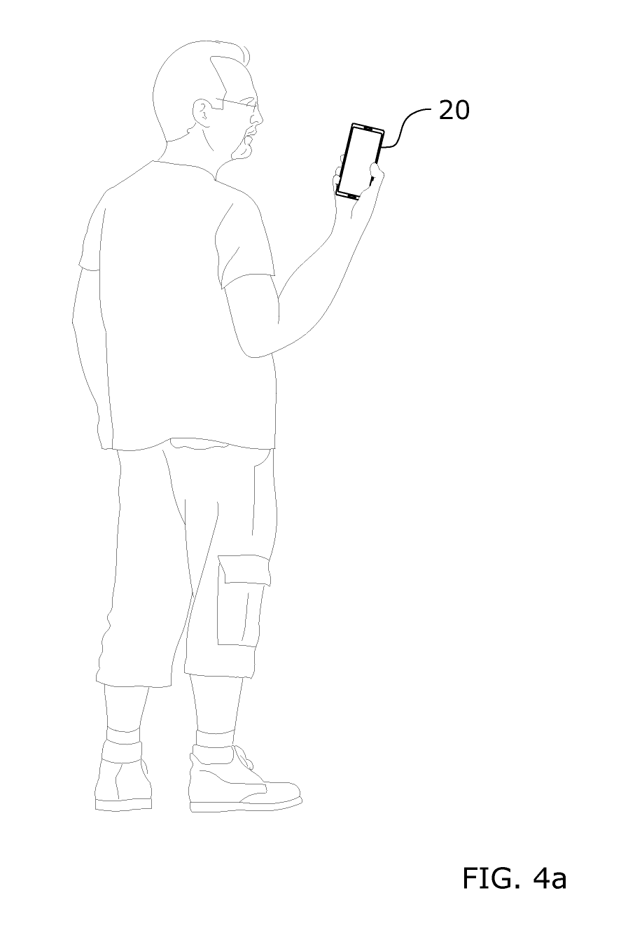

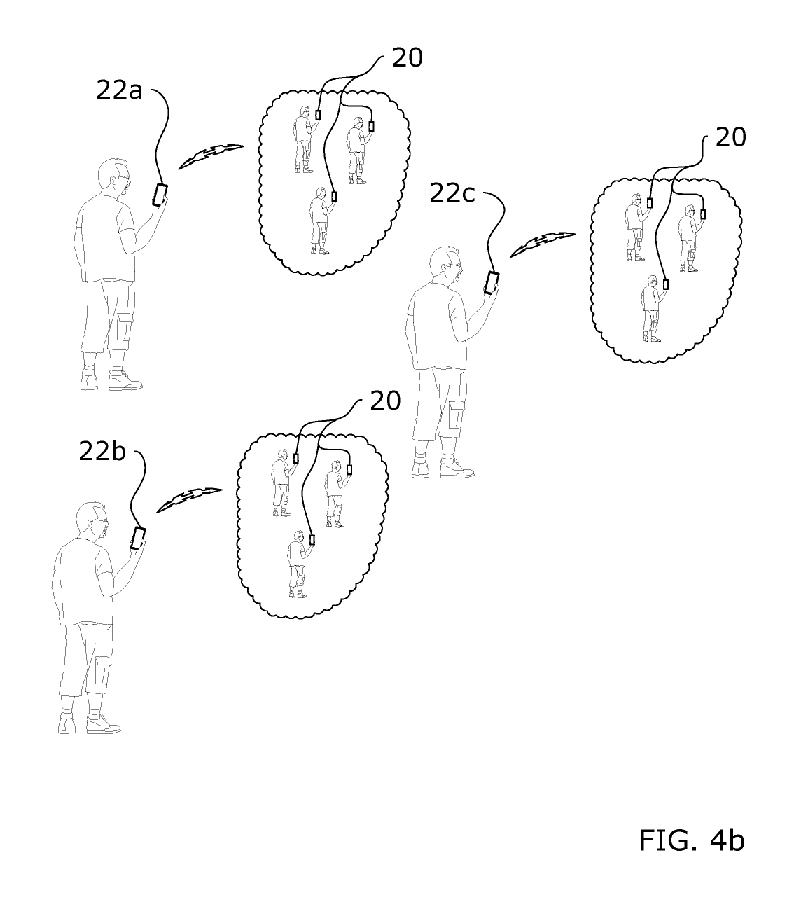

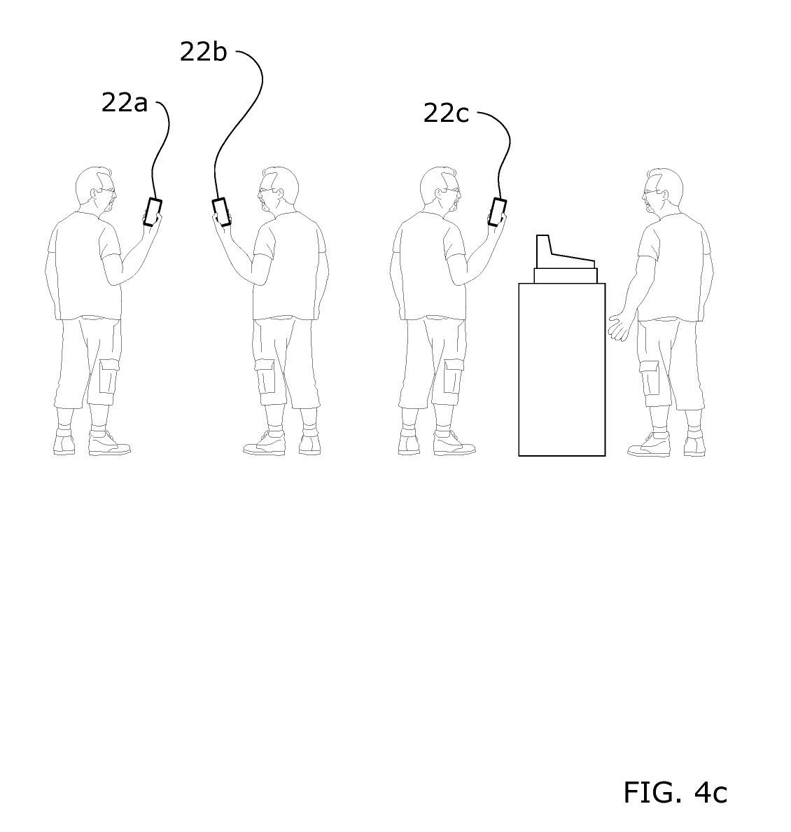

FIGS. 4a-4c illustrate the different levels of sharing the first-tier promotion and unlocking the second- and third-tier promotions. FIG. 4a illustrates a user retrieving a first-tier promotion on a user device 20. FIG. 4b illustrates badged users sharing the first-tier promotion with recipient user devices 20 to unlock virtual badges 44 for the second-tier promotion. FIG. 4c illustrates badged user devices 22a, 22b, 22c visiting the business together to redeem the third-tier promotion.

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

At least one embodiment of the business promotion system and method is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, the computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the business promotion system and method will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the business promotion system and method, suitable methods and materials are described above. Thus, the business promotion system and method is not intended to be limited to the embodiments shown, but is to be accorded the widest scope consistent with the principles and features disclosed herein.

What is claimed is:

1. A method of promoting a business, comprising:
transmitting a first-tier promotion for a business from a central server to a first user device, wherein the first-tier promotion comprises a base offer;
displaying the first-tier promotion for the business on the first user device;
sharing the first-tier promotion with a minimum number of recipient user devices by communicating the first-tier promotion from the first user device to the minimum number of recipient user devices;
identifying the first user device as a first badged device by the central server after the first-tier promotion has been shared with the minimum number of recipient user devices by the first user device;
displaying a virtual badge on the first badged device; and
transmitting a second-tier promotion for the business from the central server to the first badged device, wherein the second-tier promotion comprises the base offer and a first incentive.

2. The method of promoting a business of claim 1, further comprising the steps of:
transmitting the first-tier promotion for the business from the central server to a second user device;
displaying the first-tier promotion for the business on the second user device;
sharing the first-tier promotion with the minimum number of recipient user devices by communicating the promotion from the second user device to the minimum number of recipient user devices;
identifying the second user device as a second badged device by the central server after the first-tier promotion has been shared with the minimum number of recipient users devices by the first user device;
displaying the virtual badge on the second badged device; and
transmitting the second-tier promotion for the business from the central server to the first badged device.

3. The method of promoting a business of claim 2, further comprising the steps of:
visiting the business by the first badged device and the second badged device; and
transmitting a third-tier promotion for the business from the central server to the first badged device and the second badged device, wherein the third-tier promotion comprises the base offer and a second incentive.

4. The method of promoting a business of claim 3, wherein the second incentive is greater than the first incentive.

5. The method of promoting a business of claim 2, further comprising the step of identifying the plurality of recipient devices by the first user device.

6. The method of promoting a business of claim 5, further comprising the step of identifying the plurality of recipient devices by the second user device.

7. The method of promoting a business of claim 1, wherein the first user device comprises a mobile phone.

8. The method of promoting a business of claim 1, wherein the central server is located at the business.

9. The method of promoting a business of claim 1, wherein the minimum number of recipient devices is set by the business.

10. A method of promoting a business, comprising:
providing a first-tier promotion for a business to a first user via a first user device, wherein the first-tier promotion for the business comprises a base offer;
identifying a first plurality of recipient users by the first user via the first user device;
sharing the first-tier promotion for the business with the first plurality of recipient users identified by the first user via the first user device;
identifying the first user device as a first badged device after the first-tier promotion has been shared with a minimum number of recipient users; and
providing a second-tier promotion for the business to the first user via the first badged device, wherein the second-tier promotion for the business comprises the base offer and a first incentive.

11. The method of promoting a business of claim 10, further comprising the steps of:
receiving the first-tier promotion from the first user device by a second user via a second user device;
identifying a second plurality of recipient users by the second user via the second user device;
sharing the first-tier promotion for the business with the second plurality of recipient users identified by the second user via the second user device;
identifying the second user device as a second badged device after the first-tier promotion has been shared with the minimum number of recipient users; and
providing the second-tier promotion for the business to the second user via the second badged device.

12. The method of promoting a business of claim 11, further comprising the steps of:
receiving the first-tier promotion for the business from the second user device by a third user via a third user device;
identifying a third plurality of recipient users by the third user via the third user device;
sharing the second-tier promotion for the business with the third plurality of recipient users identified by the third user via the third user device;
identifying the third user device as a third badged device after the first-tier promotion has been shared with the minimum number of recipient users; and
providing the second-tier promotion for the business to the third user via the second badged device.

13. The method of promoting a business of claim 12, further comprising the steps of:
visiting the business by the first user, the second user, and the third user together; and
providing a third-tier promotion for the business to the first user, the second user, and the third user, wherein the third-tier promotion comprises the base offer and a second incentive.

14. The method of promoting a business of claim 13, wherein the second incentive is greater than the first incentive.

15. The method of promoting a business of claim 10, wherein the promotion comprises offering a service by the business.

16. The method of promoting a business of claim 10, wherein the minimum number of recipient users is set by the business.

17. A method of promoting a business, comprising:
offering a first-tier promotion for a business to a plurality of users via a plurality of user devices by a central server, wherein the first-tier promotion comprises a base offer;
sharing the first-tier promotion by the plurality of users;
identifying any of the plurality of users who share the first-tier promotion a minimum number of shares as a plurality of badged users; and
offering a second-tier promotion to the plurality of badged users via the plurality of user devices by the central server, wherein the second-tier promotion comprises the base offer and a first incentive.

18. The method of promoting a business of claim 17, further comprising the steps of:
visiting the business by a minimum number of badged users together; and
offering a third-tier promotion to the minimum number of badged users who visit the business together, wherein the third-tier promotion comprises the base offer and a second incentive, wherein the second incentive is greater than the first incentive.

19. The method of promoting a business of claim 18, wherein the minimum number of shares is set by the business.

20. The method of promoting a business of claim 19, wherein the minimum number of badged users is set by the business.
